(19) United States
(12) Patent Application Publication
(10) Pub. No.: US 2016/0284177 A1
(43) Pub. Date: Sep. 29, 2016

(54) ADDRESSABLE LIGHT EMITTING DIODE LIGHTING STRIP AND METHODS, USES, AND SYSTEMS THEREOF

(71) Applicant: Huizhou Light Engine Limited, Huizhou (CN)

(72) Inventors: Paul Lo, Hong Kong (CN); Eddie Ping Kuen Li, Hong Kong (CN)

(73) Assignee: Huizhou Light Engine Limited, Huizhou (CN)

(21) Appl. No.: 15/066,446

(22) Filed: Mar. 10, 2016

Related U.S. Application Data
(60) Provisional application No. 62/138,802, filed on Mar. 26, 2015.

(51) Int. Cl. G08B 7/06; H05B 33/08; H05B 37/02

(52) U.S. Cl. CPC G08B 7/066; H05B 37/0254; H05B 33/0854; H05B 37/0227; H05B 37/0236

(57) ABSTRACT

A lighting system including one or more light emitting strips, which includes a light emitting strip including a plurality of light emitting diodes along a length of the light emitting strip. The light emitting strip includes three conductors connected to the light emitting diodes in connection arrangements that permit addressing of selected ones of the light emitting diodes to illuminate the diodes. The diodes are arranged in physical groups wherein each diode in the physical group is addressed by a different address. The physical groups are repeated so that diodes having a same address, but being in different groups, are in address groups. Address signals illuminate one address group. A preconfigured controller is connected to the diodes to generate a running light display in either a forward direction or a reverse rejection. A programmable controller controls the controllers via a data line to control light operation and to detect failures. Also, a lighting system which includes a light emitting strip; a sensor configured to detect an environmental condition; and a controller connected to the sensor and configured to illuminate the light emitting strip in response to the detected environmental condition. In addition, a lighting system including an alarm system having one or more sensors controlled by an alarm system controller; an integrated controller configured to receive commands from the alarm system controller; and a light emitting strip connected to the integrated controller, wherein the integrated controller is configured to illuminate the light emitting strip based on the received commands from the alarm system. Further, a method of providing directional lighting in an emergency or security situation, including activating the lighting system discussed therein.

### CROSS-REFERENCE TO RELATED APPLICATIONS

This application claims priority to and the benefit of U.S. Ser. No. 62/138,802, filed Mar. 26, 2015, the entirety of which is incorporated by reference herein.

### BACKGROUND OF THE INVENTION

1. Field of the Invention

The present invention relates generally to a linear arrangement of light emitting diodes, and more particularly to an addressable light emitting diode (LED) strip.

2. Description of the Related Art

Conventional incandescent or LED light strips are commonly used in a variety of indoor and outdoor decorative or ornamental lighting applications. For example, such conventional light strips are used to create festive holiday signs, outline architectural structures such as buildings or harbors, and provide under-car lighting systems. These light strips are also used as emergency lighting aids to increase visibility and communication at night or when conditions, such as power outages, water immersion and smoke caused by fires and chemical fog, render normal ambient lighting insufficient for visibility.

Conventional LED light strips consume less power, exhibit a longer lifespan, are relatively inexpensive to manufacture, and are easier to install when compared to light tubes using incandescent light bulbs. More increasingly, LED light strips are used as viable replacements for neon light tubing.

Additionally, there are LED light strips that include a first bus element formed from a conductive material adapted to distribute power from a power source; a second bus element formed from a conductive material adapted to distribute power from the power source; a third bus element formed from a conductive material adapted to distribute a control signal; a plurality of LED modules, each of said plurality of LED modules comprising a microcontroller and at least one LED, each LED module having first, second, and third electrical contacts mounted on and electrically coupled to the first, second, and third bus elements, respectively, to draw power from the first and second bus elements and to receive a control signal from the third bus element; and an encapsulant encapsulating said first, second, and third bus elements, and said plurality of LED modules, including said respective microcontrollers, as shown in U.S. Pat. No. 7,988,332, the entirety of which is incorporated herein by reference into this application.

However, there is a need to further provide addressability in LED light strips in order to increase their abilities to interact and communicate to and with the general public, and expand the use of LED light strips in lighting and safety applications.

### SUMMARY OF THE INVENTION

In light of the above, there exists a need to further improve the art. The present invention provides a lighting system that includes one or more light emitting strips with addressable light emitting elements. The light emitting elements may be illuminated in sequence to indicate a direction, for example, to indicate an exit direction. The light elements that illuminate in sequence can be provided as a group of light elements, and further groups of light elements that are also illuminated in sequence can also be provided in the light strip. The resulting light pattern can be multiple groups of lights that are illuminated in sequence along the light strip. The light emitting strip of certain embodiments uses passive components, and in preferred embodiments the light emitting strip includes light emitting diodes (LEDs) and resistors. The light emitting elements are arranged in a sequential arrangement along the light emitting strip. The light emitting strip can be cut to length at any desired length of the strip, yet still provide an operating light emitting strip.

The light emitting elements in the light emitting strip are addressable in light groups. Certain embodiments of the light emitting strip provide addressing of the light groups with at least three addresses. Additional addresses corresponding to additional addressable light groups are also possible. In certain embodiments, the light emitting elements of each sequential light group are arranged sequentially in the strip. Addressing each sequential light group causes the light emitting elements to be illuminated sequentially in the strip. The light emitting elements of a light group in certain embodiments are separated from one another in the strip by lights of one or more other light groups that are separately controllable. It is also foreseen that light emitting elements of a light group can be sequentially adjacent one another in the strip in some embodiments.

The light emitting strip can be utilized for a variety of applications, for example for pathway lighting, directional lighting, emergency lighting, or signage. Lighting effects indicating motion or direction, for example, are achieved using one or more light emitting strips. Other lighting effects are of course possible.

In an exemplary embodiment, a simple and easy-to-use interface to the addressable light emitting strip is provided by an integrated circuit/micro control unit (control unit). In an exemplary embodiment, the control unit is a preconfigured control unit. The control unit is connected to the light emitting elements in the light emitting strip. The control unit serves as the control interface for controlling the light groups in the addressable light emitting strip. Using the control interface, the light emitting diodes are controlled to turn on and to turn off by light group. The control unit simplifies addressing the light groups, providing easy and reliable connection to and control of the light groups.

A programmable controller can be provided for operating the light groups according to one or more programs. The programmable controller is connected to the preconfigured control unit to implement the programmed control. The programmed control of the light groups can be used for generating light effects using the light emitting strip. For example, the programmed controller can be programmed to provide sequential lighting of the light emitting elements in the light emitting strip to indicate forward motion by sequential illumination of the lights in the strip. The programmed controller can also or instead provide control of the light emitting elements to show backward motion. Other light effects, such as a light effect to show a stop motion between light effects showing forward motion and/or backward motion are possible. In certain examples, the light emitting strips can be provided to show motion through a traffic or pedestrian intersection. An example provides light motion as a guide to control traffic flow through a three-way intersection. Another example provides emergency lighting using one or more light emitting strips, which by light effects to show direction of movement to safety.

The programmable controller of certain embodiments can provide diagnostics of the lighting system, such as self-diagnostics of the lighting system. The programmable controller can indicate problems or failure of elements in the lighting system. The programmable controller can be programmed for set up of lighting system including determining available lights and light groups in the lighting set up. The programmable controller can be programmed to control lighting in complex layouts or complex patterns of light display.

In an exemplary embodiment, a lighting system is provided that includes a light emitting strip, a sensor configured to detect an environmental condition, and a controller connected to the sensor and configured to illuminate the light emitting strip in response to the detected environmental condition. The environmental condition can be an audio or visual alert generated by a fire or emergency alarm system.

In an exemplary embodiment, a lighting system is provided that includes an alarm system having one or more sensors controlled by an alarm system controller, an integrated controller configured to receive commands from the alarm system controller, and a light emitting strip connected to the integrated controller. In some embodiments, the integrated controller is configured to illuminate the light emitting strip based on the received commands from the alarm system.

In an exemplary embodiment, a method of providing directional lighting in an emergency or security situation is utilized. The method can include activating a lighting system that includes one or more light emitting strips, light emitting strip comprises a plurality of light emitting diodes arranged along the light emitting strip; three conductors extending along the light emitting strip and connected to selected ones of the light emitting diodes, the connected conductors defining at least three addresses for illuminating at least three distinct address groups of the light emitting diodes; the light emitting diodes of the at least three address groups being grouped together in a physical group in the light emitting strip; a controller connected to the three conductors, the controller being configured and operable to output the three addresses so as to illuminate the light emitting diodes by address group, the controller being operable in two output states, in the first output state the controller outputs the addresses in a forward order and in the second output state the controller outputs the address in a reverse order; and a data line connected to the controller, the controller being operable to receive control signals on the data line. The emergency situation can include, but limited to fire, smoke, medical emergency, flood, earthquake, biohazard, biological, chemical or nuclear weapons, blackout, building collapse, any situation that poses an immediate risk to health, life, property, or environment, and/or a combination thereof. The security situation can include, but not limited to, robbery, terrorism, gun shooting, trespass by suspicious individual, fugitive escape, riot, hostage crisis, and/or a combination thereof.

In an exemplary embodiment, the method can include activating a lighting system that includes a light emitting strip, a sensor configured to detect an environmental condition, and a controller connected to the sensor and configured to illuminate the light emitting strip in response to the detected environmental condition. The environmental condition can be an audio or visual alert generated by a fire or emergency alarm system.

In an exemplary embodiment, the method can include activating a lighting system that includes an alarm system having one or more sensors controlled by an alarm system controller, an integrated controller configured to receive commands from the alarm system controller, and a light emitting strip connected to the integrated controller. In some embodiments, the integrated controller is configured to illuminate the light emitting strip based on the received commands from the alarm system.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1A is a top plan view of a strip of light emitting diodes connected according to the principles of the present invention;

FIG. 1B is a top plan view of a strip of light emitting diodes connected according to the principles of the present invention;

FIG. 2A is a signal diagram showing the timing of signals to be used with a light emitting diode strip according to an exemplary embodiment;

FIG. 2B is a signal diagram showing the timing of signals to be used with a light emitting diode strip according to an exemplary embodiment;

FIG. 3 is a block circuit diagram of control units connected to a light emitting diode strip according to an exemplary embodiment;

FIG. 4 is a block circuit diagram of control units connected to a light emitting diode strip according to an exemplary embodiment;

FIG. 5 is a block circuit diagram of a polarity detection device according to an exemplary embodiment;

FIGS. 6A-6B illustrate light emitting diode strip pathways according to exemplary embodiments;

FIG. 7 illustrates a single-station system according to an exemplary embodiment;

FIG. 8 illustrates an integrated system according to an exemplary embodiment;

FIG. 9 illustrates an example mounting position of a light emitting strip and a corresponding single-station system and/or integrated system according to an exemplary embodiment; and

FIG. 10 illustrates a notification appliance circuitry (NAC) according to an exemplary embodiment.

### DETAILED DESCRIPTION OF THE PREFERRED EMBODIMENTS

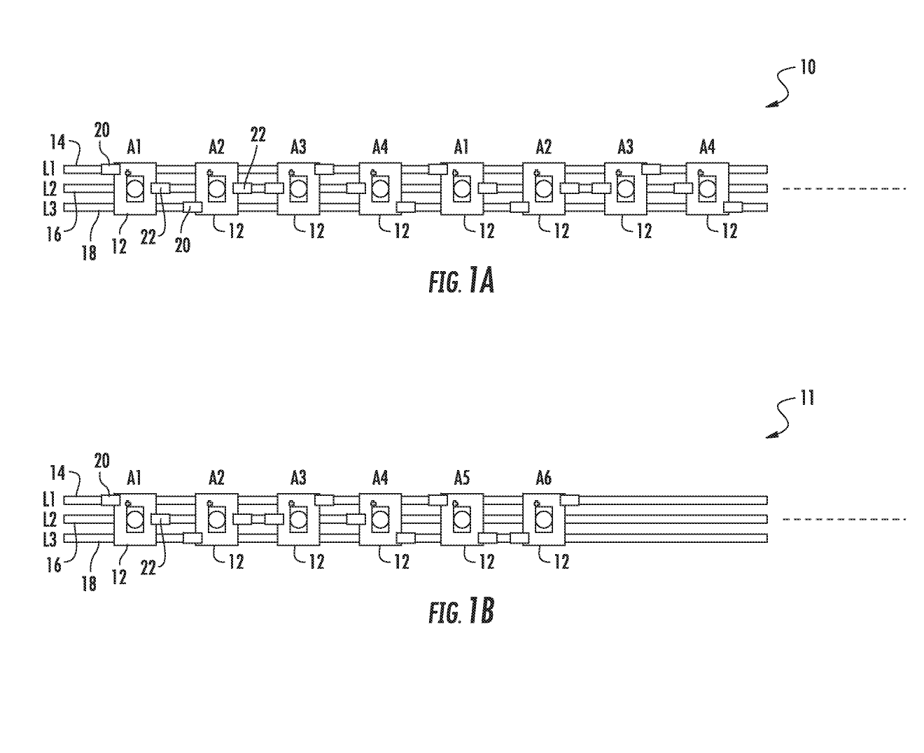

In FIG. 1A, a light emitting strip 10 includes a plurality of light emitting diodes 12 arranged in a linear arrangement on a strip substrate. The strip substrate can be a printed circuit board (PCB), a flexible-PCB (F-PCB), a conductive rod, a copper plate, a copper clad steel plate, a copper clad alloy, a base material coated with a conductive material, or another substrate as would be understood by one of ordinary skill in the art. The light emitting strip 10 includes first, second and third conductors 14, 16 and 18 disposed on the strip substrate that extend through the whole length of the light emitting strip 10. The three conductors 14, 16 and 18 are also indicated as L1, L2, and L3 in the FIG. 1A. Each of the light emitting diodes 12 is provided with two connectors 20 and 22. The connectors 20 and 22 can be configured to connect a respective light emitting diode 12 to two of the three conductors 14, 16, or 18. The connectors 20 and 22 can include one or more resistors, inductors, and/or capacitors.

In the illustration, the connectors 20 are connected at a left side, which corresponds to the anode of the corresponding light emitting diode 12. The connectors 22 are connected to the right side, which corresponds to the cathode of the corresponding light emitting diode 12. The arrangement of the connectors 20 and 22 connecting each of the light emitting diodes 12 to the conductors 14, 16 and 18 enables the light emitting diodes 12 to be addressed (turned on) by signals applied to the conductors 14, 16, and 18. The light emitting diodes 12 can be connected to the strip substrate via connectors 20/22 using one or more connection technologies, including, for example, surface mounting, chip bonding, soldering, welding, riveting, conductive epoxy, or one or more other electrically conductive bonding/connection techniques.

The light emitting strip 10 can be fully or partially encapsulated using one or more encapsulants. The encapsulant provides protection against environmental elements, such as water and dust, and damage due to loads placed on light emitting strip 10. The encapsulant can be flexible or rigid, and transparent, semi-transparent, opaque, and/or colored. The encapsulant may be made of, but not limited to, polymeric materials such as polyvinyl chloride (PVC), polystyrene, ethylene vinyl acetate (EVA), polymethylmethacrylate (PMMA), polyvinylidene difluoride (PVDF), Fluorinated ethylene propylene (FEP), elastomer materials such as silicon rubber, or other similar materials.

Fabrication techniques concerning the encapsulant include, without limitation, extrusion, casting, molding, laminating, or a combination thereof.

In addition to its protective properties, the encapsulant assists in the scattering and guiding of light in the light emitting strip. For example, a portion of the light from the light emitting diodes which satisfies the total internal reflection condition will be reflected on the surface of the encapsulant and transmitted longitudinally along the encapsulant. Light scattering particles can be included in the encapsulant to redirect such portions of the light. The size of the light scattering particles can be chosen for the wavelength of the light emitted from the light emitting diodes. In an exemplary embodiment, the light scattering particles can have a diameter in the scale of nanometers and they can be added to the polymer either before or during an extrusion process.

The light scattering particles can also be a chemical by-product associated with the preparation of the encapsulant. Any material that has a particle size (e.g., a diameter in the scale of nanometers) which permits light to scatter in a forward direction can be a light scattering particle.

The concentration of the light scattering particles can be varied by adding or removing the particles. For example, the light scattering particles can be in the form of a dopant added to the starting material(s) before or during the extrusion process. The concentration of the light scattering material within the encapsulant can be influenced by the distance between light emitting diodes, the brightness of the light emitting diodes, and/or the uniformity of the emitted light. A higher concentration of light scattering material can increase the distance between neighboring light emitting diodes within the light emitting strip. The brightness of the light emitting strip can be increased by employing a high concentration of light scattering material together within closer spacing of the light emitting diodes and/or using brighter light emitting diodes. The smoothness and uniformity of the light within the light emitting strip can be improved by increasing the concentration of light scattering material.

The cross-sectional profile of the encapsulant is not restricted to circular or oval shapes, and may be any shape (e.g., square, rectangular, trapezoidal, star, D-shaped). Also, the cross-sectional profile of the encapsulant can be optimized to provide tensing for light emitted by the light emitting diodes. For example, another thin layer of encapsulant can be added outside the original encapsulant to further control the uniformity of the emitted light.

The surface of the light emitting strip can be textured and/or tensed for optical effects. The light emitting strip can be coated (e.g., with a fluorescent material), or include additional layers to control the optical properties (e.g., the diffusion and consistency of illuminance) of the light emitting strip. Additionally, a mask can be applied to the outside of the encapsulant to provide different textures or patterns.

Different design shapes or patterns can also be created at the surface of the encapsulant by means of hot embossing, stamping, printing and/or cutting techniques to provide functions such as lensing, focusing, and/or scattering effects. For example, the surface of the encapsulant can include formal or organic shapes or patterns (e.g., dome, waves, ridges) which influences light rays to collimate, focus, or scatter/diffuse. The surface of the encapsulant can be textured or stamped during or following extrusion to create additional lensing. Additionally, the encapsulant can be made with multiple layers of different refractive index materials in order to control the degree of diffusion.

Depending on the number of different connections of the light emitting diodes 12 to the conductors 14, 16 and 18, different numbers of addresses are possible. In certain embodiments, three addresses are possible. In the illustrated embodiment, four addresses are provided. Other arrangements of connections of the light emitting diodes 12 to the conductors can be provided. For example, a light emitting strip 11 having six addresses is illustrated in FIG. 1B. The number of addresses is not limited to these example values, and a light emitting strip can have a different number of addresses as would be understood by those skilled in the relevant art.

If the illustrated light emitting strip 10 were provided with only four light emitting diodes, the four addresses would enable each light emitting diode 12 to be lit or not individually. However, in a light emitting strip including many diodes, connection arrangements to the conductors 14-18 are repeated. The repeated connections define address groups of light emitting diodes 12 that are illuminated by the corresponding addresses. The number of addresses for a light emitting strip 10 defines the number of address groups of light emitting diodes 12 in the strip 10.

FIG. 1A shows an arrangement that includes four addresses for the light emitting diodes 12 in the strip 10. The addressable light emitting diodes 12 are indicated as A1, A2, A3, and A4 to denote the four addresses used to illuminate the diodes and also to indicate the diodes of each address group. A distinction will be made between address groups and physical groups. The four diodes A1, A2, A3 and A4 are physically located together on the strip 10 and so can be designated as a physical group. The first addressable light emitting diode 12 is designated A1 for the first address. The first diode 12 has the connector 20 connected to the first conductor 14 (which is also denoted L1) at the input side, and the second connector 22 connected to the second conductor 16 (also denoted L2) at the output side. The arrangement of the connectors 20 and 22 determine the address that will result in the diode being illuminated.

The second light emitting diode 12 in the strip 10 is denoted A2 and includes the first connector 20 connected to the third conductor 18, denoted L3, and the second connector 22 connected to the second conductor 16, denoted L2. The address to illuminate the second diode thus differs from the address to illuminate the first diode.

The third light emitting diode in the strip 10 is denoted A3 and includes the first connector 20 connected to the conductor 16, or L2, and the second connector 22 connected to the conductor 14, or L1. The address to illuminate the third diode differs from the address for the first and second diodes.

The fourth light emitting diode in the strip 10 is denoted A4 and includes the first connector 20 connected to the second conductor 16, or L2, and the second connector 22 connected to the third conductor 18, or L3. The fourth diode is illuminated by an address that differs from the addresses to illuminate the first, second, and third diodes. The first, second, third and fourth diodes form a first physical group, although they are members of four separate address groups.

A fifth light emitting diode 12 in the illustrated strip 10 is connected to the conductors in the same pattern as that of the first diode in the strip. The fifth diode is denoted A1 to indicate that the first address can be used to illuminate the diode. The addressing and connection of the fifth diode is a repeat of the first diode. By applying the first address to the conductors 14, 16 and 18, both the first diode and the fifth diode are illuminated. Any other diodes with the same connection as the first and fifth diodes will also be illuminated. The first, fifth and any other similarly connected diodes define a first addressed group of diodes. The first and fifth diodes are in different physical groups.

By examining FIG. 1A, it can be seen that the connections to the sixth diode in the strip is a repeat of the connections to the second diode and thus both are designated A2. Applying the second address to the conductors 14, 16 and 18 results in the second and sixth diodes illuminating, as well as any other similarly connected diodes. The second, sixth, and any other similarly connected diodes define a second address group of diodes that are illuminated at the same time by applying the second address.

The seventh diode is connected in the same manner as the connections to the third diode, and so is illuminated by the same address and defines a third address group that will illuminate at the same time. The eighth diode is a repeat of the connections and addressing of the fourth diode. The eighth and fourth diodes and any other similarly connected diodes are illuminated together in a fourth address group.

In the illustrated example, a similar repeating pattern of four addressable diodes are provided in sequence along the length of the light emitting strip 10. Applying any of the four possible addresses will result in every fourth diode illuminating. Applying a next sequential address will result in a next sequential diode in the repeating pattern being illuminated. A further next sequential address applied to the conductors illuminates a further next sequential diode in the repeating pattern. By applying the addresses sequentially, the address groups of lights are illuminated so that a running light display is provided. The direction of the running light display is determined by applying the addresses in either the forward sequence or the reverse sequence, so that forward running lights or reverse running lights are illuminated. Of course, it is also possible that the sequence of addresses can be halted at a current active address or address group of lights to stop the motion of the running lights. The running lights can be operated to indicate forward motion, reverse motion and/or stop motion in any order.

The running lights provide one illuminated light within each physical group. The repeating physical groups of diodes result in an illuminated running light within each physical group. In the illustrated example, every fourth light is illuminated at the same time and moves along the light emitting strip 10 in step with the other illuminated lights. The spacing between the illuminated lights is maintained while the running lights giving the appearance of motion by the lights along strip 10 to the viewer.

Other arrangements for addressing more or fewer address groups of diodes are possible and within the scope of this invention. Other arrangements of lights within an address group or within a physical group are possible. For example two or more lights of a same address group can be provided in the same physical group, for example, adjacent to each other. Instead of dots of light appearing to move along the strip, dashes of lights can appear to move along the strip.

The arrangement of light emitting diodes in the strip 10 can begin and/or end with diode connected with a different connection than that shown. For example, the strip 10 can begin with the diode connected so as to be illuminated by the second address A2. It is also possible that the end most diode can be connected to illuminate at the third or fourth address A3 or A4. Any beginning or ending diode can include any available address. The addressing of the diodes 12 need not be provided in the order shown, but the diodes can be arranged in a different connection and/or addressing order.

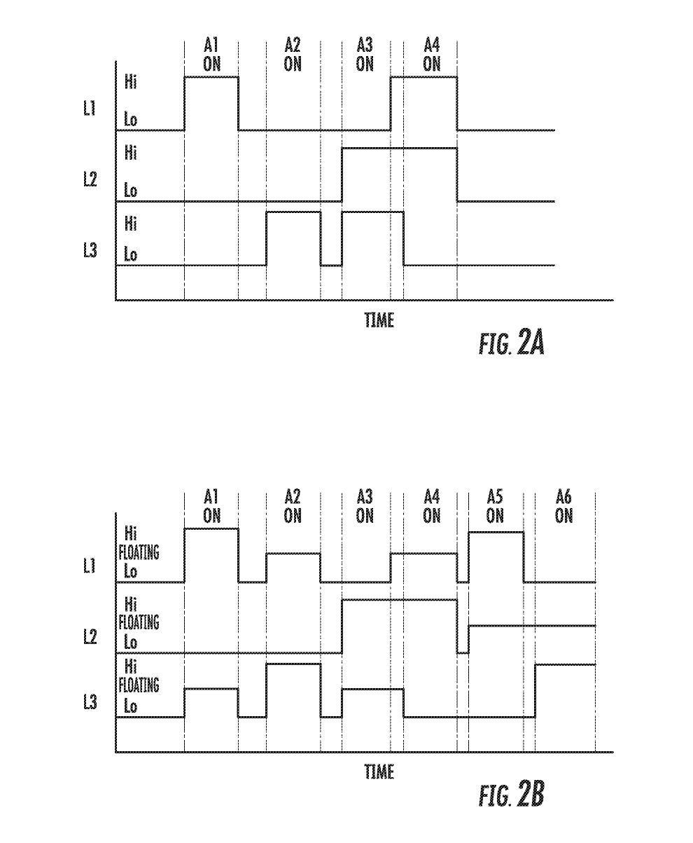

The illustrated configuration provides four addresses for addressing four address groups of the light emitting diodes 12 in the strip 10. FIG. 2A shows signals that can be applied to the three conductors L1, L2 and L3 to address the four address groups of diodes 12. The signals applied to the conductors L1, L2 and L3 can be generated by one or more external controllers (not shown). The external controller(s) can include one or more circuit(s), processor(s), logic, and/or code that are configured to generate the signals to control the illumination of one or more light emitting diodes connected to the conductors L1, L2 and L3. The external controller(s) can also be configured to fade in/fade out the lights and various motion effects using dimmed lights. For example, by applying a signal, such as an analog signal or a digital signal at a frequency, can be used to achieve dimming or fade in and fade out. Examples of frequencies to achieve the effect are signals at about 200 Hz to about 1 kHz.

The address group of diodes denoted A1 are addressed by a high signal on the first conductor L1 and a low signal on the second and third conductors L2 and L3. The illumination signal is determined by the connections of the connectors 20 and 22. All of the diodes 12 in the address group addressed by the address A1 will illuminate, regardless of their position along the strip 10. The other diodes in the strip 10 will remain off, or unilluminated.

To address the address group A2 diodes, a high signal is applied to the third conductor L3 and the first and second conductors L1 and L2 have low signals. Applying the address A2 to the strip 10 causes the first address group of diodes A1 to turn off and causes the second address group of diodes A2 to illuminate. Where the diodes of A1 and A2 are adjacent each other in the strip, the lights appear to move or jump from one location to the next adjacent location on the strip.

Addressing all of the A3 address group diodes is accomplished by applying a low signal to the first conductor L1 and high signals to the second and third conductors L2 and L3. The address group A3 diodes will illuminate and the other address groups will be unilluminated. To address the A4 address group diodes, a high signal is provided to the first and second conductors L1 and L2, while a third conductor L3 has a low signal. This signal will keep address groups A1, A2 and A3 in the off or unilluminated state and will light only the A4 address group diodes.

Using the signals shown, the four different address groups of diodes are addressed by address group and can be turned on or off as a group. With three conductors, it is possible to address six address groups of diodes in each strip as illustrated in FIG. 1B. FIG. 2B shows signals that can be applied to the three conductors L1, L2 and L3 to address the six address groups of diodes 12 of FIG. 1B. The operation of the signals shown in FIG. 2B is similar to the operation in FIG. 1B. For example, to address the group of diodes denoted A1, a high signal is applied to the first conductor 14 (L1), a low signal on the second conductor 16 (L2), and a floating signal on the third conductor 18 (L3). To address the group of diodes denoted A2, a floating signal is applied to the first conductor 14 (L1), a low signal on the second conductor 16 (L2), and a high signal on the third conductor 18 (L3), and so on. In this example, a floating signal has a value in between the values of the high and low signals. In an exemplary embodiment, the floating signal value is equally between or substantially equally between the high and low signal values. However, the value of the floating signal is not limited to this example and other values can be used as would be understood by those skilled in the relevant arts. Further, the number of possible addresses can be changed as needed.

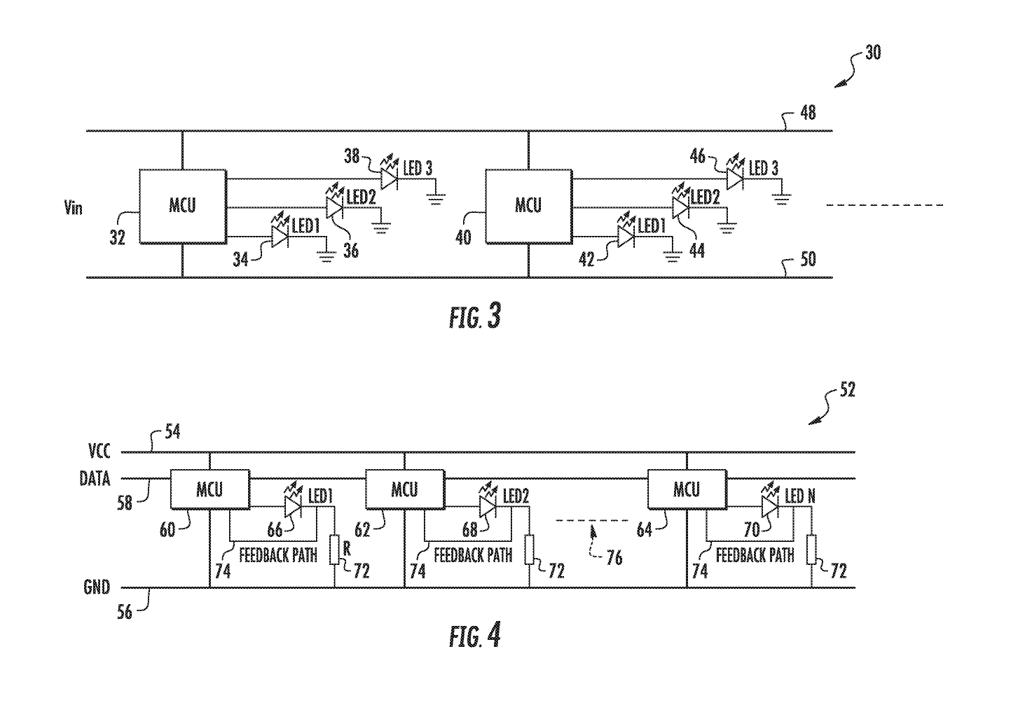

Turning to FIG. 3, a light emitting strip 30 is shown having one or more light emitting modules. Each of the light emitting modules includes a micro control units (MCU) 32 configured to control one or more light emitting diodes. In an exemplary embodiment, the MCUs 32/40 are preconfigured. The MCUs 32 and/or 40 can include one or more circuit(s), processor(s), logic, and/or code that are configured to control the illumination of one or more light emitting diodes connected thereto. In an exemplary embodiment, the MCUs 32 and/or 40 can be configured to generate one or more pulse-width modulation (PWM) signals to control the illumination of the light emitting diode(s). The PWM signal can be, for example, 200 Hz.

The light emitting strip 30 includes three address groups of addressable light emitting diodes 34, 36 and 38 that are connected to and controlled by MCU 32. Each of the addressable light emitting diodes 34, 36, and 38 can include one or more light emitting diodes. Further, one or more physical groups of light emitting diodes are controlled by MCU 32, where a physical group can include one or more of the addressable light emitting diodes. The maximum number of light emitting diodes controlled by the MCU 32 and/or the maximum number of light emitting diodes per address group depends on the number of Input/Output (I/O) ports of the MCU 32. In FIG. 3, the MCU 32 is configured to generate three addresses. Three addresses results in three address groups of light emitting diodes 34, 35 and 38 being independently addressed in the light emitting strip. In particular, the MCU 32 generates a first address, for example the address signal A1, and outputs it to the light emitting strip so that the first address group of light emitting diodes 34 is illuminated. The MCU 32 then outputs the second address, for example the address A2, to illuminate the second address group of light emitting diodes 36. Thereafter, the MCU 32 outputs the third address, for example A3, to illuminate the third address group of light emitting diodes 38.

A MCU 40 is connected to control diode address groups 42, 44 and 46, the description of which is substantially similar to the MCU 32 and diodes 34, 36 and 38. The light emitting strip 30 is not limited to two light emitting modules and can include any number of light emitting modules as would be understood by one of ordinary skill in the relevant arts.

Each of the MCUs 32 and 40 can control the diodes of a single physical group or can control the diodes of multiple physical groups.

The MCUs 32 and 40 are connected to receive an input voltage Vᵢₙ at leads 48 and 50. Applying a voltage across the leads 48 and 50 at a predetermined level causes the MCUs 32 and 40 to operate. In certain embodiments, applying a positive voltage of the predetermined level across the signal lead 48 and the lead 50 triggers the MCUs 34 and 40 to generate addresses to the light emitting diode address groups to indicate a forward motion. For example, the MCU 32 sends the address to illuminate the first diode 34, then the second diode 36, and then the third diode 38. Similarly, the MCU 40 sends addresses to illuminate the first diode 42, followed by the second diode 44 and then the third diode 46. The first diodes are denoted LED 1 in the drawing, the second diodes are denoted as LED 2, and the third diodes are denoted as LED 3.

If an inverted voltage is applied to the voltage input Vᵢₙ the MCUs 32 and 40 operate to output the addresses in the reverse order. In other words, an inverted polarity at the leads 48 and 50 triggers the third diodes LED3 to be illuminated, followed by the second diodes LED2 and then the first diodes LED 1.

The visual effect by the light emitting strip 10 is that the positive input voltage triggers a forward moving running light pattern, and the inverted voltage triggers a backward moving running light pattern.

Each MCU 32 of certain embodiments is connected to drive a light emitting strip that includes three address groups of light emitting diodes. Other numbers of address groups are possible.

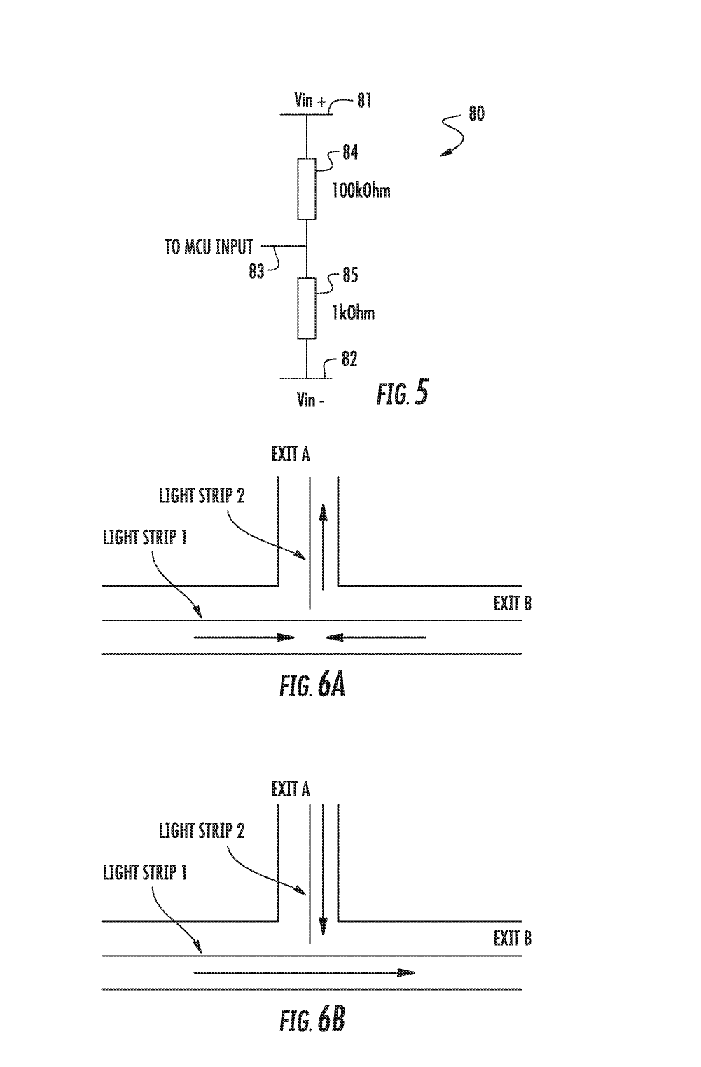

In an exemplary embodiment, the MCU 32 and/or the MCU 40 can include a polarity detection device 80 that is configured to determine the polarity of a voltage applied across the leads 48 and 50. The polarity detection device 80 can include one or more passive components (e.g., resistors, inductors, capacitors, etc.) configured to detect the polarity of an applied voltage. The polarity detection device 80 can additionally or alternatively include one processors, logic and/or code that are configured to detect the polarity of an applied voltage. FIG. 5 illustrates a polarity detection device 80 according to an exemplary embodiment. As illustrated, the polarity detection device 80 can include two resistors 84 and 85 connected in series between the leads 48 and 50 (leads 81 and 82, respectively in FIG. 5). The MCU 32 and/or MCU 40 can be configured to measure the voltage and/or current at the node between the resistors 84 and 85 to determine the polarity of the voltage. In an exemplary embodiment, the resistors 84 and 85 can have resistances of 100 KΩ and 1 KΩ, respectively. The resistance values are not limited to these values and can be other resistances as would be understood by one of ordinary skill in the relevant arts.

In FIG. 4 is shown light emitting strip 52 according to an exemplary embodiment. The light emitting strip 52 includes a power line 54, denoted V_{cc}, a ground line 56, denoted GND, and a data line 58, denoted DATA. The light emitting strip 52 can include one or more light emitting modules each having a controller and one or more light emitting diodes. As illustrated, each module includes an MCU 66, 68, 70, configured to control connected light emitting diode 66, 68 and 70, respectively. The MCUs 66, 68 and 70 can include one or more circuit(s), processor(s), logic, and/or code that are configured to control the illumination of one or more light emitting diodes connected thereto. The MCUs may be the same or different than the MCUs 32 and/or 40 illustrated in FIG. 3.

The diodes 66, 68 and 70 can each be an individual diode or can represent a plurality of diodes. A resistor element 72 is provided in series with each diode 66, 68 and 70. A feedback path 74 is connected between each of the diodes 66, 68 and 70 and the respective resistor 72 to provide the feedback signal back to the MCUs 60, 62, and 64. In an exemplary embodiment, the MCUs 60, 62 and/or 64 are programmable. Further, the programmable MCUs 60, 62 and/or 64 can be programmed via data line 58.

As illustrated, a light emitting module (also referred to as a diode control unit) can include a control unit, such as MCU 60, a diode, such as diode 66, a resistor 72 and a feedback path 74, all connected as shown to the power line 54, ground line 56 and the data line 58. Three such diode control units are shown, LED1, LED2, and LEDn, but as indicated by the ellipses 76, more are possible.

In an exemplary embodiment, the light emitting strip 52 can be controlled and/or programmed by an external control unit (not shown) that is connected to the data line 58. The external control unit can include one or more circuit(s), processor(s), logic, and/or code that are configured to generate one or more commands and/or signals to program and/or control one or more of the MCUs 60, 62, and/or 64. The external controller can also be configured to receive and process feedback information received from one or more of the MCUs 60, 62, and/or 64 via the data line 58. In operation, the external commands/signals can trigger programmed operations, such as operating the light emitting strip to provide forward running lights or backward running lights. Individual segments (physical groups) can be controlled as well. In an exemplary embodiment, the external controller can be configured to generate one or more commands and/or signals based on, for example, one or more signals received from a building management system, fire alarm system, emergency system, etc. For example, the external controller can be configured to generate a forward moving lighting signal to direct light motion towards an exit in response to receiving a signal from a fire alarm system.

The number of light emitting diodes controlled by each MCUs 60, 62 and 64 can be determined by the operating voltage, for example, for diodes connected in a serial connection. The number of diodes can be determined by the number of I/O ports on the MCUs, for example for individual control of the diodes.

The MCUs 60, 62 and 64 can be configured to monitor the output current provided to the diodes and generate a failure report that is transmitted as a message sent to an external control unit via the data line 58.

The light emitting strip 52 can be self-addressing. The self-addressing can be imitated upon the power-on of the light emitting strip 52 and/or periodically by one or more external controllers. In operation, the external controller(s) can generate an address initiation signal (also referred to as a trigger, fresh, and/or refresh signal) and provide it to one or more of the MCUs via the data line 58. For example, the MCU 60 can assign the light emitting diode 66 as address 1 in response to an address initiation signal. The assigned address can then be provided to the next MCU 62, which can then assign light emitting diode 68 with the next available address, and so on.

The last MCU 64 can be configured to detect an open end to the light emitting strip or other failure by detecting an open circuit, short circuit, over and/or under voltage, etc. The MCU 64 can be configured to report the failure message to one or more of the other MCUs and/or external controllers via the data line 58. The report can be in the form of the number of control units, number of addressable light emitting diodes, etc. in the light emitting strip 50.

The MCUs 60, 62, and/or 64 can be configured to fade in/fade out the lights and various motion effects using dimmed lights. For example, by applying a signal, such as an analog signal or a digital signal at a frequency, can be used to achieve dimming or fade in and fade out. Examples of frequencies to achieve the effect are signals at about 200 Hz to about 1 kHz.

In one or more of the exemplary embodiments, the light emitting diodes can be illuminated in a blinking configuration at a blinking frequency. The blinking frequency can be, for example, 10 Hz, but is not limited to this frequency.

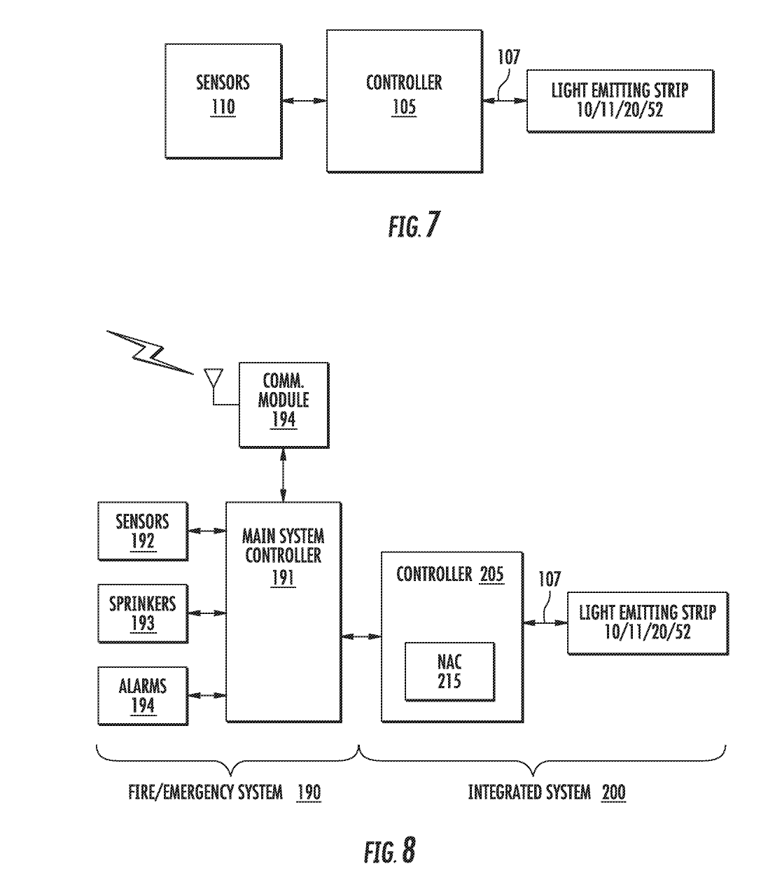

One or more light emitting strips can be used to designate pathways as illustrated in FIGS. 6A and 6B. In FIG. 6A, a single light emitting strip (designated as “light strip 1”) can display more than one direction, which can be useful at a three way road junction, for example. As illustrated, the light strip 1 includes light emitting diodes configured to illuminate a forward motion (left to right in the figure) towards the intersection of the pathway leading to Exit A. The light strip 1 also includes light emitting diodes configured to illuminate a backwards motion (right to left in the figure) from Exit B towards the intersection of the pathway leading to Exit A. The configuration having multiple directions within a single light emitting strip can be realized using, for example, the light emitting strips 30 and/or 52 of FIGS. 3 and 4, respectively.

FIG. 6B illustrated an intersection of two pathways according to another embodiment. In this example, each of the light strip 1 and light strip 2 are configured to illuminate motion in a single direction. Light strip 2 is configured as illuminated motion towards the intersection with light strip 1, and light strip 1 is configured as illuminated motion towards Exit B. As this is a simpler configuration, the embodiment can be realized using, for example, the light emitting strips 10, 11, 30 and/or 52.

A lighting system includes a light emitting strip including a plurality of light emitting diodes along a length of the light emitting strip. The light emitting strip includes three conductors connected to the light emitting diodes in connection arrangements that permit addressing of selected ones of the light emitting diodes to illuminate the diodes. The diodes are arranged in physical groups wherein each diode in the physical group is addressed by a different address. The physical groups are repeated so that diodes having a same address, but being in different groups, are in address groups. Address signals illuminate one address group. A preconfigured controller is connected to the diodes to generate a running light display in either a forward direction or a reverse rejection. A programmable controller controls the controllers via a data line to control light operation and to detect failures.

Thus, there is shown and described a visible pathway guiding apparatus. The visible pathway guiding apparatus can be provided by a lighting strip with three or more addresses for the lights in the strip. The light emitting strip is formed of passive components, only LEDs and resistors in certain embodiments, which can be cut to a desired length. The lights are addressable in address groups to achieve lighting effects. The programmable controller permits lighting effects to be applied to complex lighting layouts and provides self-diagnostics of the system.

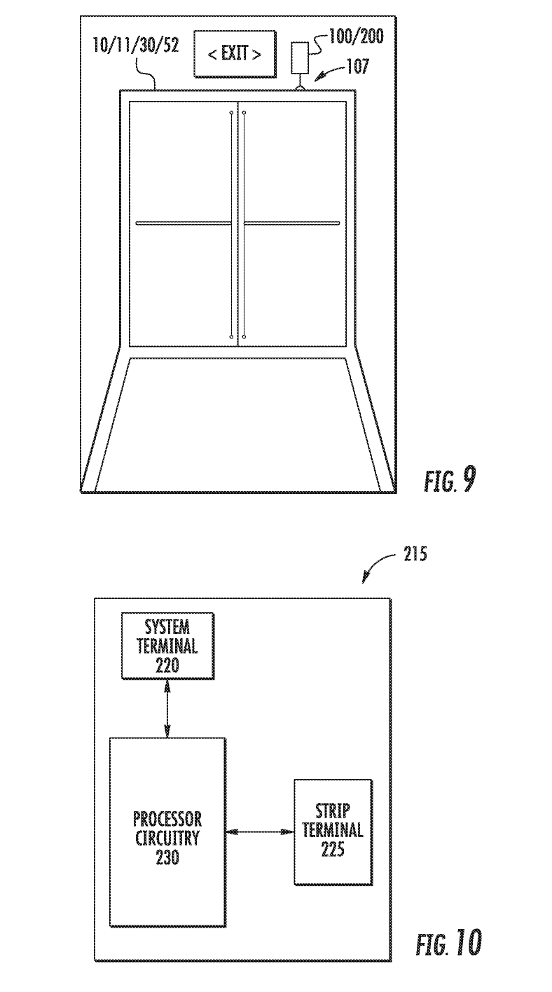

In exemplary embodiments, the light emitting strips 10, 11, 30, and/or 52 can be used in a visible pathway guidance system. The visible pathway guidance system can be a single-station system 100 as illustrated in FIG. 7 or an integrated system 200 that is implemented in a security and/or emergency system 190 as illustrated in FIG. 8.

In operation, the single-station system 100 and/or the integrated system 200 can deliver linear stroboscopic and/or static-light luminary configurations situated around and/or adjacent to doorways, pathways, and/or egresses alert and/or provide guidance in emergency and/or security situations. For example, the single-station system 100 and/or the integrated system 200 can be configured to alert/notify occupants of a building to the existence of a fire or other emergency condition when the fire alarm or other system in the building is activated; demark specific predetermined egress path or exit doorways, and/or other points or along a path of egress with bright flashing (or constant) light; and/or to direct occupants to the exit and out of the building.

With reference to FIG. 7, the single-station system 100 can be configured to use audible, visual, and/or other environmental conditions to activate one or more light emitting strips of the single-station system 100.

In an exemplary embodiment, the single-station system 100 can include one or more sensors 110 configured to detect one or more environmental conditions and a controller 105 having one or more circuit(s), processor(s), logic, and/or code that are configured to monitor environmental conditions detected by the sensor(s) 110 and to activate emergency and/or security operations based on the detected environmental condition(s). Upon activation, the controller 105 can be configured to illuminate the light emitting strip 10/11/30/52. The controller 105 can be connected to one or more light emitting strips 10/11/30/52 via a connector 107.

The one or more sensors 110 can include one or more audible sensors, visual sensors, temperature sensors, smoke sensors, air quality sensors, and/or one or more other sensors as would be understood by those skilled in the relevant arts.

In an exemplary embodiment, the one or more sensors 110 can be configured to detect tonal patterns and/or frequency values of an audible signal generated by, for example, a code compliant smoke alarm. The tonal patterns and/or frequency values of the audible signal can be sampled by the controller 105 periodically, for example, every 2 seconds. Based on the tonal patterns and/or frequency values of the signal, the controller 105 can be configured to activate the visible pathway guidance system (e.g., illuminate the light emitting strip).

In an exemplary embodiment, the light emitting strip(s) can mounted along a pathway and/or around an exit door. The light emitting strips can be mounted using one or adhesives (e.g., a silicone based adhesive), mounting clip, and/or one or more other mounting means as would be understood by one of ordinary skill in the relevant arts.

In an exemplary embodiment, the single-station system 100 can be mounted adjacent to and/or within audible/visual range of a smoke or other emergency audio/visual alarm. Based on the proximity, the single-station system 100 can monitor audio, visual, or other alerts generated by the alarm to determine when to activate the visible pathway guidance system (e.g., illuminate the light emitting strip). For example, the single-station system 100 can be placed on, for example, the ceiling near the smoke or other emergency audio/visual alarm. The single-station system 100 can also be place on an upper portion of a wall, a lower portion of a wall, above a door, or the like. An example mounting position is illustrated in FIG. 9. In this example, one or more light emitting strips 10/11/30/52 are mounted around an exit doorway and form an illuminated pathway along the lower edges of the walls of the hallway leading towards the doorway. The single-station system 100 (and/or an integrated system 200) can be connected to the one or more light strip(s) via connector 107. Although shown mounted above the doorway, the systems 100/200 can be mounted in other areas along the one or more light strip(s).

In an exemplary embodiment, the single-station system 100 can be configured to activate the visible pathway guidance system (e.g., illuminate the light emitting strip) based on firefighter personal alert safety system (PASS) devices operating within the listening radius of the single-station system 100.

In an exemplary embodiment, the single-station system 100 can be configured to operate on, for 9 VDC supplied by a power supply and/or a battery.

FIG. 8 illustrates an integrated system 200 according to an exemplary embodiment. The integrated system 200 can be implemented in a security and/or emergency system 190. The integrated system 200 can include a controller 205 connected to one or more light emitting strips 10/11/30/52 via a connector 107. The controller 205 can include one or more circuit(s), processor(s), logic, and/or code that are configured to control the overall operation of the integrated system 200, including processing one or more signals received from the fire/emergency system 190. Based on the received signal(s), the controller 205 can be configured to illuminate the light emitting strip 10/11/30/52.

The controller 205 can include notification appliance circuitry (NAC) 215 that is configured to connect the integrated system 200 to the main system controller 191, and to monitor fire/emergency alarms detected by the fire/emergency system 190. As illustrated in FIG. 10, the NAC 215 can include a system terminal 220 that is configured to connect the NAC 215 to the main system controller 191, a strip terminal 225 that is configured to connect to one or more light emitting strips 10/11/30/52 via a connector 107, and processor circuitry 230 communicatively coupled to the system and strips terminals 220 and 225. The processor circuitry 230 can include one or more circuit(s), processor(s), logic, and/or code that are configured to process one or more signals received from the fire/emergency system 190, and to illuminate the light emitting strip 10/11/30/52. The illumination of the strip(s) can be based on the one or more of the processed signals.

The fire/emergency system 190 can include one or more sensors 192. The sensor(s) 192 can include one or more audible sensors, visual sensors, temperature sensors, smoke sensors, air quality sensors, and/or one or more other sensors as would be understood by those skilled in the relevant arts.

Based on environmental conditions detected by the sensor(s) 192, the controller 191 can be configured to activate one or more alarms 194. The alarms 194 can include one or more visual (e.g., strobes) and/or audio alarms. In operation, the controller 205 and/or the NAC 215 can be configured to synchronize the illumination of the light emitting strip with the visual/audio alarms 194 of the fire/emergency system 190.

In an exemplary embodiment, the fire/emergency system 190 can include a communication module 194 configured to transmit and/or receive communications via one or more wireless and/or wired communication protocols. In an exemplary embodiment, the communication module 194 can be configured to receive one or more commands from, for example, emergency response personnel. The received commands can be received, for example, wirelessly. In response to the received commands, the controller 205 can be configured to illuminate one or more light emitting strips 10/11/30/52. For example, if the emergency personal intend to direct people towards a particular exit or along a particular pathway, the command can control the controller 205 to initiate illumination of the light emitting strip(s) consistent with the desired exit/pathway.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purpose of this discussion, a processor can include a microprocessor, a digital signal processor (DSP), or other hardware processor. The processor can be “hard-coded” with instructions to perform corresponding function(s) according to embodiments described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein. Further, a circuit can include an analog circuit, a digital circuit, state machine logic, other structural electronic hardware, or a combination thereof.

Although specific embodiments have been illustrated and described herein, it will be appreciated by those of ordinary skill in the art that a variety of alternate and/or equivalent implementations may be substituted for the specific embodiments shown and described without departing from the scope of the present invention. This provisional application is intended to cover any adaptations or variations of the specific embodiments discussed herein. Therefore, it is intended that this invention be limited only by the claims and the equivalents thereof.

What is claimed is:

1. A lighting system, comprising:
one or more light emitting strips, light emitting strip comprises a plurality of light emitting diodes arranged along the light emitting strip;
three conductors extending along the light emitting strip and connected to selected ones of the light emitting diodes, the connected conductors defining at least three addresses for illuminating at least three distinct address groups of the light emitting diodes;
the light emitting diodes of the at least three address groups being grouped together in a physical group in the light emitting strip;
a controller connected to the three conductors, the controller being configured and operable to output the three addresses so as to illuminate the light emitting diodes by address group, the controller being operable in two output states, in the first output state the controller outputs the addresses in a forward order and in the second output state the controller outputs the address in a reverse order; and
a data line connected to the controller, the controller being operable to receive control signals on the data line.

2. A lighting system as claimed in claim 1, wherein the controller is a first controller and further comprising at least a second controller connected to the data line, the first controller being operable to assign itself an address and to transmit the address to the second controller via the data line.

3. A lighting system as claimed in claim 1, wherein the controller is operable to monitor an output current of the controller and to generate a failure signal upon interruption of the output current.

4. A lighting system as claimed in claim 1, wherein the diodes are connected to the conductors to provide four address groups of diodes.

5. A lighting system as claimed in claim 1, wherein the controller is operable to reverse an address order of output signals to the light emitting diodes upon receiving an inverted input voltage.

6. A lighting system as claimed in claim 2, wherein the second controller is configured and operable to report an open circuit in the light emitting strip via the data line.

7. A lighting system, comprising:
a light emitting strip;
a sensor configured to detect an environmental condition; and
a controller connected to the sensor and configured to illuminate the light emitting strip in response to the detected environmental condition.

8. A lighting system as claimed in claim 7, wherein the environmental condition is an audio or visual alert generated by a fire or emergency alarm system.

9. A lighting system, comprising:
an alarm system having one or more sensors controlled by an alarm system controller;
an integrated controller configured to receive commands from the alarm system controller; and
a light emitting strip connected to the integrated controller,
wherein the integrated controller is configured to illuminate the light emitting strip based on the received commands from the alarm system.

10. A method of providing directional lighting in an emergency or security situation, comprising:
activating the lighting system of claim 1.

11. A method of providing directional lighting in an emergency or security situation, comprising:
activating the lighting system of claim 7.

12. A method of providing directional lighting in an emergency or security situation, comprising:
activating the lighting system of claim 9.
